(19) United States
(12) Patent Application Publication
(10) Pub. No.: US 2026/0050562 A1
(43) Pub. Date: Feb. 19, 2026

(54) WIRE REDUCTION IN A HIGH PERFORMANCE INTERFACE

(71) Applicant: NVIDIA Corp., Santa Clara, CA (US)

(72) Inventors: Jyotirmaya Swain, Bangalore (IN); Pranjali Deshmukh, Bangalore (IN); Swapnil Tapadia, Bangalore (IN); Harshil Jain, Udaipur (IN); Poojan Patel, Ahmedabad (IN)

(73) Assignee: NVIDIA Corp., Santa Clara, CA (US)

(21) Appl. No.: 18/806,992

(22) Filed: Aug. 16, 2024

(51) Int. Cl. G06F 13/20

(52) U.S. Cl. CPC G06F 13/20; G06F 2213/40

(57) ABSTRACT

Signaling interfaces that include physical channels for requests and physical channels for responses to the requests utilizing first-in-first-out (FIFO) buffers configured to receive signals from one of the physical channels and packetizers configured to transform, into packets on a reduced bus, (a) signals from the physical channels for the requests and responses, and (b) credit signals for the FIFO buffers, and wherein the reduced bus has a width narrower than a combined width of the physical channels.

### BACKGROUND

AMBA (Advanced Microcontroller Bus Architecture) compliant interfaces may be utilized as high-performance communication buses in processor chips and multi-chip packages and circuit boards. AMBA-compliant interfaces provide high-bandwidth communication between different subsystems within a processor-based system. AMBA interfaces have been widely adopted using protocols such as AHB (Advanced High-performance Bus), APB (Advanced Peripheral Bus), and AXI (Advanced extensible Interface). These protocols are tailored to different aspects of connectivity and performance requirements for AMBA-compliant interfaces.

The APB protocol is tailored for use with lower-bandwidth applications such as providing control signals between chips or between chips and peripheral devices. The AXI protocol is tailored to high-frequency, high-bandwidth applications. The AXI protocol performs well at higher bandwidths but comes with the cost of requiring a higher interface pin count than for example the APB protocol. The APB protocol may be implemented over interfaces with lower pin counts than interfaces supporting the AXI protocol. A third protocol, AHB, provides a trade-off between the pin counts and performance of AXI and APB.

In some networking fabrics, many traffic initiators and many traffic targets may require the performance of AXI. Hence, the central portion of the network may utilize AXI-compliant interfaces. Slower devices on the edges of the central network may be serviced with APB-compliant interfaces in leaf networks (lower performance peripheral switches and fabrics) of the central network. This heterogeneous mix of interface types may lead to congestion of the network bus traces, particularly in the central network.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 depicts an exemplary communication network fabric.

FIG. 2 depicts aspects of a conventional AXI interface in one embodiment.

FIG. 3 depicts aspects of a bus-reduction mechanism in one embodiment.

FIG. 4 depicts an embodiment of a bus-reduction mechanism in one embodiment wherein the initiator and target components are graphics processing units.

FIG. 5 depicts additional aspects of an embodiment of a bus reduction mechanism.

FIG. 6 depicts exemplary packetized formats for AXI bus channels.

FIG. 7 depicts a parallel processing unit 702 in accordance with one embodiment.

FIG. 8 depicts a general processing cluster 800 in accordance with one embodiment.

FIG. 9 depicts a memory partition unit 900 in accordance with one embodiment.

FIG. 10 depicts a streaming multiprocessor 1000 in accordance with one embodiment.

FIG. 11 depicts a processing system 1100 in accordance with one embodiment.

FIG. 12 depicts an exemplary processing system 1200 in accordance with another embodiment.

FIG. 13 depicts an exemplary processing system 1300 in accordance with another embodiment.

### DETAILED DESCRIPTION

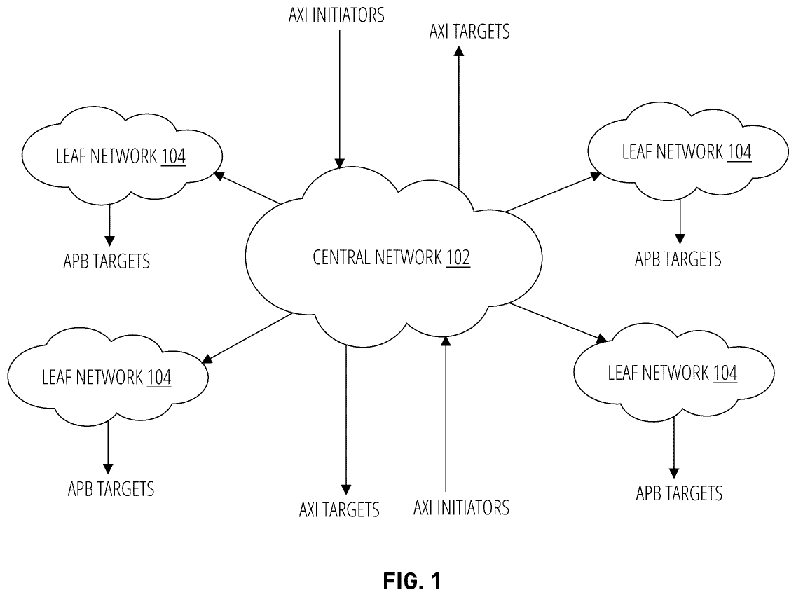

FIG. 1 depicts an exemplary communication network fabric that may be utilized, for example, for communicating data and control signals between processors, between processors and memory devices, and to and from peripheral devices in a computer system.

A high-bandwidth central network 102 region of the communication fabric may implement multiple AXI-compliant interfaces. Each of these interfaces may comprise five physical channels, each physical channel comprising a pin and a wire. These channels that may be referred to as AR, AW, W, B, and R. Each physical channel comprises a multi-wire bus.

The AR and AW channels may function as request channels that propagate command attributes for READS and WRITES to and from a memory device (e.g., a random-access memory device). The W channel may be utilized to communicate the data to write to memory, and the B channel may be utilized to receive WRITE responses back from the memory. The R channel may be utilized to receive READ responses. Each of these channels may sometimes be utilized to convey requester-specific attributes using protocol-defined USER fields.

Various leaf networks 104 of the communication fabric may implement APB interfaces to components with lower performance requirements than the components coupled to the AXI interfaces.

The bus path widths may not be uniform throughout the communication fabric. The widths of the buses in particular regions of the fabric may vary depending on performance requirements, and may have widths (numbers of wires) for example of 32, 64, 128, or even up to 1024.

The central network 102 of the network may in some embodiments comprise multiple independent AXI buses, one each for traffic in two directions. This effectively doubles the wire count in the central network 102 region. These wires for carrying heavy central traffic may be routed through areas of a chip specifically dedicated to that purpose. Wires don't scale down in size at the same rate as logic gates in advanced chip manufacturing processes. As the size and density of logic gates decreases with advancing processes, the high wire count/density in the central network 102 of the data network on the chip may have an increasingly negative impact on the overall chip area and cost.

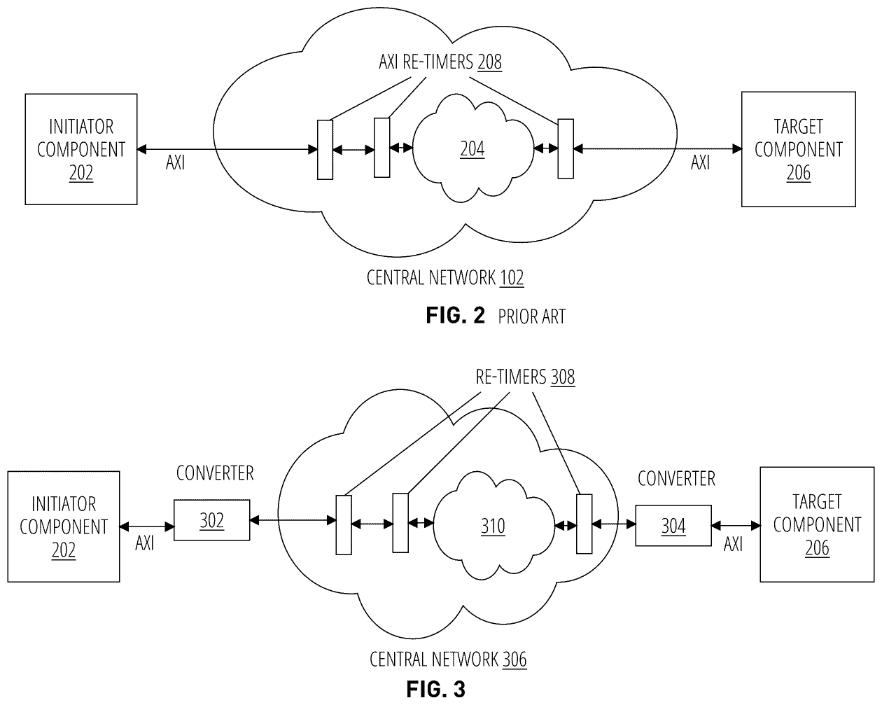

FIG. 2 depicts aspects of a conventional AXI interface and bus in one embodiment. An initiator component 202 (e.g., a data processor) communicates data and commands on the AXI bus to the central network 102, where a switching network 204 routes these signals to a target component 206. A number of re-timing circuits 208 are utilized along the AXI bus to compensate for signaling delays introduced by the system's components and by the bus itself.

FIG. 3 depicts an embodiment of a bus-reduction mechanism in one embodiment. The multiple physical channels of an AXI bus are reduced in wire count via packetizing and de-packetizing converters 302, 304. The reduction of the individual physical channel buses of the AXI bus to a reduced-width (fewer metal traces) common bus through the central network 306 reduces wire congestion in the central network 306 while maintaining the functionality of the individual AXI physical channels. The bandwidth performance of the reduced common bus is also comparable to that of the AXI bus under many prevalent traffic conditions in the central network 306. The reduction of the bus width through the central network 306 has the further benefit of enabling a reduction in size and/or complexity of components such as the re-timing circuits 308 and switches in the switching network 310.

High bandwidth communications links may utilize a number of re-timing circuits along their length. These re-timing circuits account for a substantial portion of the circuit area needed to implement the links. Typical AXI re-timing circuits 208 (being Valid-Ready based) may utilize a skid-stage based design, which may be approximately three times larger than the re-timing circuits 308 (being Valid-Credit based) for comparable bus width and performance. The effective area savings may be substantial, for example:

TABLE 1

| Data | AXI Bus | Reduced Bus | Wire | Re-Timing Circuit |
|---|---|---|---|---|
| Width | Width | Width | Reduction | Area Reduction |
| 32 | 330 | 110 | 67% | 83% |
| 64 | 398 | 178 | 55% | 78% |
| 128 | 534 | 314 | 41% | 71% |
| 256 | 806 | 586 | 27% | 64% |

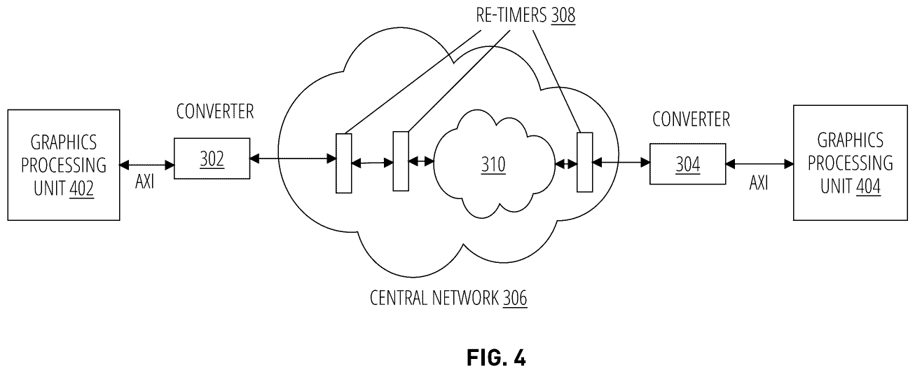

In one particular embodiment, the initiator and target components on the AXI bus may be graphics processing units 402, 404 as depicted in FIG. 4.

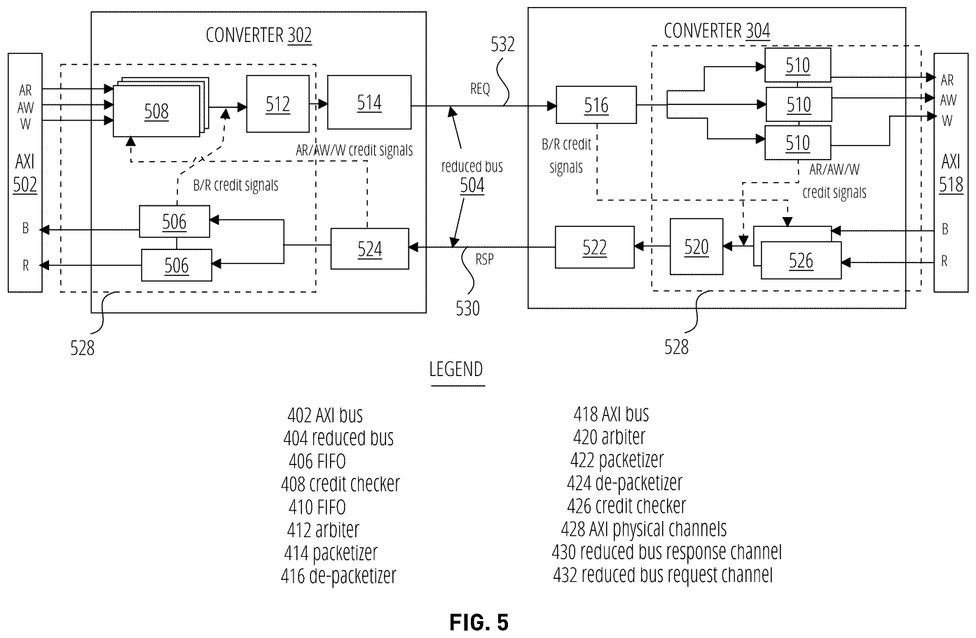

FIG. 5 depicts additional aspects of a bus reduction mechanism in one embodiment. An initiator component 202 (e.g., a processor) communicates memory commands over the AR and AW physical channels of an AXI bus 502. For WRITE commands, data to write to the memory may be communicated over the W physical channel of the AXI bus 502. The AR, AW, and W AXI physical channels 528 share the reduced bus request channel 532 (REQ). The B and R AXI physical channels 528 of the AXI bus 502 utilized by the initiator component 202 are coupled to output FIFOs 506 (First-In-First-Out buffers) of the converter 302. The B and R AXI physical channels 528 share the response bus (RSP) of the reduced bus response channel 530.

The AR, AW, and W physical channels are each applied to a respective credit checker 508 in the converter 302 (one credit checker 508 per physical channel). The credit checkers 508 for the AR/AW/W traffic apply credits supplied over the B and R response channels. The credits indicate available space for each traffic type in the corresponding AR/AW/W traffic FIFOs 510. If there are credits for a particular request traffic type, it may pass the request traffic arbiter 512.

Traffic on the AW/AR/W channels that passes the arbiter 512 is packetized (converted into packets by request packetizer 514) and communicated, in packetized form, over the reduced bus request channel 532, which comprises fewer metal traces than does the combined AW/AR/W physical channels of the AXI bus 502. To support the independence of the various traffic types from one another, signals from the different physical channels (which may operate independently or semi-independently from one another) may be interspersed with one another in the packet traffic generated on the reduced bus 504. An exemplary format of the packets is described below.

At the converter 304, the packets are converted back to un-packetized traffic (using de-packetizer 516) on the three physical AW/AR/W channels. The un-packetized traffic is buffered in respective FIFOs 510 for output to the AXI bus 518 to the target component 206 of the traffic (e.g., a memory device). As an optimization in one embodiment, the AW and W type packets may share a single FIFO.

Credit signals for the different request traffic types are generated to indicate available space for additional such traffic in the destination request traffic FIFOs 510. These credit signals pass through the response arbiter 520 and are packetized by the response packetizer 522 into credit packets. The credit packets are communicated over the reduced bus response channel 530 to the response de-packetizer 524, which provides the credit signals to the request credit checkers 508.

Response traffic on the B and R physical channels of the AXI bus 518 is applied to the response traffic credit checkers 526 (one credit checker 526 per physical channel). B and R channel traffic with credit passes the arbiter 520 and is packetized (at packetizer 522) for transmission over the reduced bus response channel 530, where it is restored to the individual B and R physical channels by the de-packetizer 524).

Credit signals for the different response traffic types are generated to indicate available space for additional such traffic in the destination response traffic FIFOs 506. These credit signals pass through the request arbiter 512 and are packetized by the request packetizer 514 into credit packets. The credit packets are communicated over the reduced bus request channel 532 to the request de-packetizer 516, which provides the credit signals to the response credit checkers 526.

Despite sharing a physical bus as packets, the various AXI physical channels 528 retain functional independence from one another due to the independent end-end virtual channels enabled by packetized crediting of the respective physical traffic types and exchanging the credit packets through the same physical interface as the data and control packets. Credit signals for both of requests and responses are assigned higher priorities than other traffic types at the arbiters 512, 520.

The crediting mechanism associated with each traffic type operates to avoid head-of-line (HOL) blocks. An HOL block is a performance degradation that arises when the first packet at the front of the queue (head of the line) cannot be forwarded due to some form of resource contention or routing issues, despite subsequent packets in the queue being ready for transmission. This blocking occurs in network switches, routers, or other networking devices that operate based on the first-in, first-out (FIFO) queueing principle. HOL blocks may be particularly impactful in situations where multiple FIFOs implement physical channels that are required to operate independently of one another, such as is the case with the physical channels of AXI interfaces.

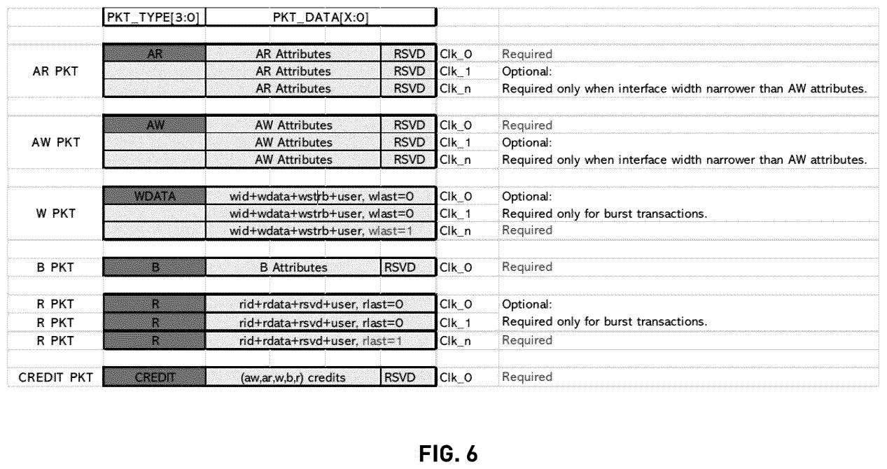

FIG. 6 depicts exemplary packetized formats for AXI bus channels. Each packet comprises a TYPE field and a DATA field. The TYPE field distinguishes between the various packet types (i.e., the AXI channel a packet encodes). The DATA field comprises a command (CMD) or DATA contents.

The packetization overhead on overall performance is typically minimal for AXI burst transfers due to inherent low command bandwidth requirements and if required, this overhead may be compensated by marginally increasing the fabric clock frequency.

Packets other than credit packets and B-type packets may require multiple clock cycles to traverse between the requestor AXI bus 502 and the target AXI bus 518 according to the width of the AXI bus (and hence, the width of the reduced bus) being utilized. In the case of packets needing multiple cycles to transmit, control packets (AR/AW) may be transmitted back-to-back (with no intervening packets of other traffic types), and data packets (W/R) may be interleaved with packets for other traffic types. The widths of the REQ and RSP channels on the reduced bus may be aligned to the W and R channel widths so that data transport performance is not impacted by packetization. AR and AW type packets may in some embodiments be transported over multiple clock cycles (if required) due to their lower (than for other packet types) bandwidth requirements.

The bus reduction mechanisms disclosed herein may be implemented computing devices utilizing one or more graphic processing unit (GPU), network processors such as network adapters, switches and data processing units (DPU), and/or general purpose data processor (e.g., a ‘central processing unit or CPU). Exemplary architectures will now be described that may be configured with the bus reduction mechanisms disclosed herein.

The following description may use certain acronyms and abbreviations as follows:
“DPC” refers to a “data processing cluster”;
“GPC” refers to a “general processing cluster”;
“I/O” refers to a “input/output”;
“L1 cache” refers to “level one cache”;
“L2 cache” refers to “level two cache”;
“LSU” refers to a “load/store unit”;
“MMU” refers to a “memory management unit”;
“MPC” refers to an “M-pipe controller”;
“PPU” refers to a “parallel processing unit”;
“PROP” refers to a “pre-raster operations unit”;
“ROP” refers to a “raster operations”;
“SFU” refers to a “special function unit”;
“SM” refers to a “streaming multiprocessor”;
“Viewport SCC” refers to “viewport scale, cull, and clip”;
“WDX” refers to a “work distribution crossbar”; and
“XBar” refers to a “crossbar”.

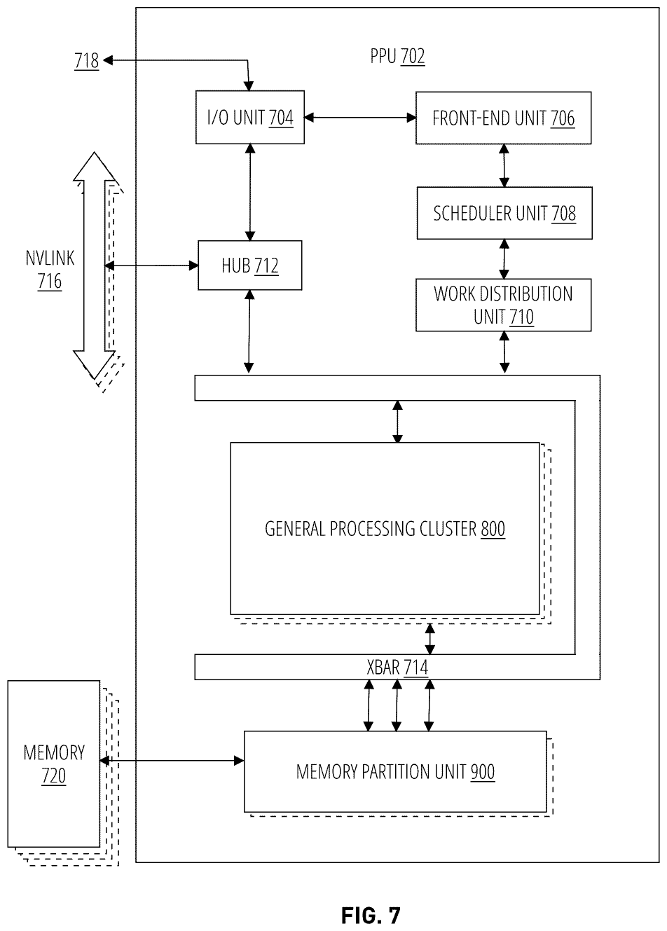

FIG. 7 depicts a parallel processing unit 702, in accordance with an embodiment. In an embodiment, the parallel processing unit 702 is a multi-threaded processor that is implemented on one or more integrated circuit devices. The parallel processing unit 702 is a latency hiding architecture designed to process many threads in parallel. A thread (e.g., a thread of execution) is an instantiation of a set of instructions configured to be executed by the parallel processing unit 702. In an embodiment, the parallel processing unit 702 is a graphics processing unit (GPU) configured to implement a graphics rendering pipeline for processing three-dimensional (3D) graphics data in order to generate two-dimensional (2D) image data for display on a display device such as a liquid crystal display (LCD) device. In other embodiments, the parallel processing unit 702 may be utilized for performing general-purpose computations. While one exemplary parallel processor is provided herein for illustrative purposes, it should be strongly noted that such processor is set forth for illustrative purposes only, and that any processor may be employed to supplement and/or substitute for the same.

One or more parallel processing unit 702 modules may be configured to accelerate thousands of High Performance Computing (HPC), data center, and machine learning applications. The parallel processing unit 702 may be configured to accelerate numerous deep learning systems and applications including autonomous vehicle platforms, deep learning, high-accuracy speech, image, and text recognition systems, intelligent video analytics, molecular simulations, drug discovery, disease diagnosis, weather forecasting, big data analytics, astronomy, molecular dynamics simulation, financial modeling, robotics, factory automation, real-time language translation, online search optimizations, and personalized user recommendations, and the like.

As shown in FIG. 7, the parallel processing unit 702 includes an I/O unit 704, a front-end unit 706, a scheduler unit 708, a work distribution unit 710, a hub 712, a crossbar 714, one or more general processing cluster 800 modules, and one or more memory partition unit 900 modules. The parallel processing unit 702 may be connected to a host processor or other parallel processing unit 702 modules via one or more high-speed NVLink 716 interconnects.

Embodiments of the mechanisms disclosed herein may be utilized for example in one or more of the NVLink 716, interconnect 718, and the crossbar 714.

The parallel processing unit 702 may be connected to a host processor or other peripheral devices via an interconnect 718. The parallel processing unit 702 may also be connected to a local memory comprising a number of memory 720 devices. In an embodiment, the local memory may comprise a number of dynamic random access memory (DRAM) devices. The DRAM devices may be configured as a high-bandwidth memory (HBM) subsystem, with multiple DRAM dies stacked within each device. The memory 720 may comprise logic to configure the parallel processing unit 702 to carry out aspects of the techniques disclosed herein.

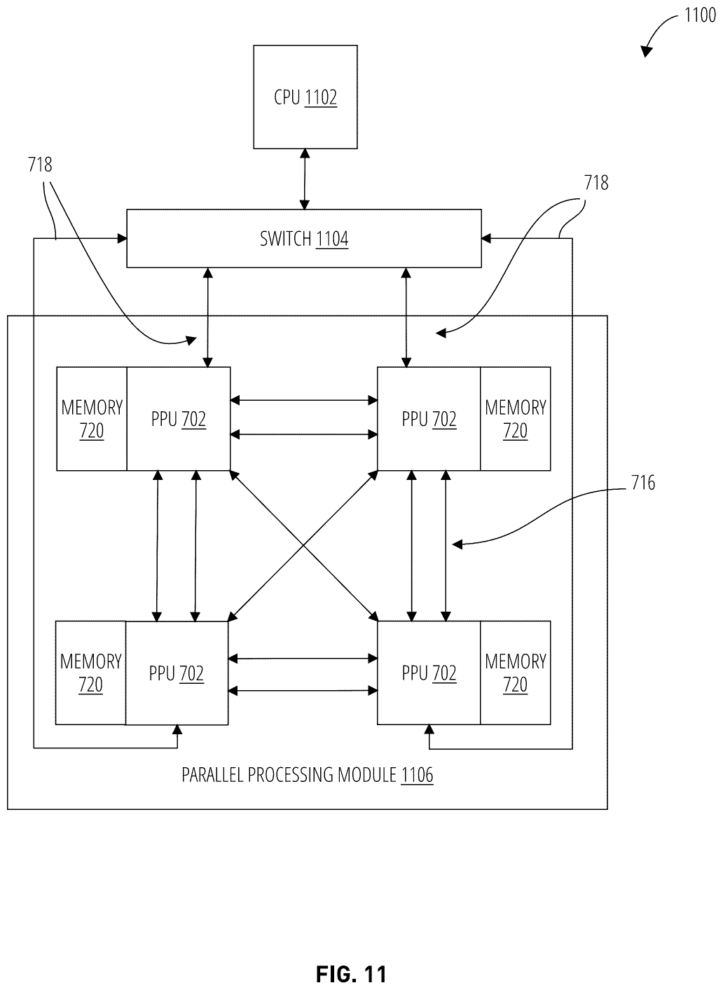

The NVLink 716 interconnect enables systems to scale and include one or more parallel processing unit 702 modules combined with one or more CPUs, supports cache coherence between the parallel processing unit 702 modules and CPUs, and CPU mastering. Data and/or commands may be transmitted by the NVLink 716 through the hub 712 to/from other units of the parallel processing unit 702 such as one or more copy engines, a video encoder, a video decoder, a power management unit, etc. (not explicitly shown). The NVLink 716 is described in more detail in conjunction with FIG. 11.

The I/O unit 704 is configured to transmit and receive communications (e.g., commands, data, etc.) from a host processor (not shown) over the interconnect 718. The I/O unit 704 may communicate with the host processor directly via the interconnect 718 or through one or more intermediate devices such as a memory bridge. In an embodiment, the I/O unit 704 may communicate with one or more other processors, such as one or more parallel processing unit 702 modules via the interconnect 718. In an embodiment, the I/O unit 704 implements a Peripheral Component Interconnect Express (PCIe) interface for communications over a PCIe bus and the interconnect 718 is a PCIe bus. In alternative embodiments, the I/O unit 704 may implement other types of well-known interfaces for communicating with external devices.

The I/O unit 704 decodes packets received via the interconnect 718. In an embodiment, the packets represent commands configured to cause the parallel processing unit 702 to perform various operations. The I/O unit 704 transmits the decoded commands to various other units of the parallel processing unit 702 as the commands may specify. For example, some commands may be transmitted to the front-end unit 706. Other commands may be transmitted to the hub 712 or other units of the parallel processing unit 702 such as one or more copy engines, a video encoder, a video decoder, a power management unit, etc. (not explicitly shown). In other words, the I/O unit 704 is configured to route communications between and among the various logical units of the parallel processing unit 702.

In an embodiment, a program executed by the host processor encodes a command stream in a buffer that provides workloads to the parallel processing unit 702 for processing. A workload may comprise several instructions and data to be processed by those instructions. The buffer is a region in a memory that is accessible (e.g., read/write) by both the host processor and the parallel processing unit 702. For example, the I/O unit 704 may be configured to access the buffer in a system memory connected to the interconnect 718 via memory requests transmitted over the interconnect 718. In an embodiment, the host processor writes the command stream to the buffer and then transmits a pointer to the start of the command stream to the parallel processing unit 702. The front-end unit 706 receives pointers to one or more command streams. The front-end unit 706 manages the one or more streams, reading commands from the streams and forwarding commands to the various units of the parallel processing unit 702.

The front-end unit 706 is coupled to a scheduler unit 708 that configures the various general processing cluster 800 modules to process tasks defined by the one or more streams. The scheduler unit 708 is configured to track state information related to the various tasks managed by the scheduler unit 708. The state may indicate which general processing cluster 800 a task is assigned to, whether the task is active or inactive, a priority level associated with the task, and so forth. The scheduler unit 708 manages the execution of a plurality of tasks on the one or more general processing cluster 800 modules.

The scheduler unit 708 is coupled to a work distribution unit 710 that is configured to dispatch tasks for execution on the general processing cluster 800 modules. The work distribution unit 710 may track a number of scheduled tasks received from the scheduler unit 708. In an embodiment, the work distribution unit 710 manages a pending task pool and an active task pool for each of the general processing cluster 800 modules. The pending task pool may comprise a number of slots (e.g., 32 slots) that contain tasks assigned to be processed by a particular general processing cluster 800. The active task pool may comprise a number of slots (e.g., 4 slots) for tasks that are actively being processed by the general processing cluster 800 modules. As a general processing cluster 800 finishes the execution of a task, that task is evicted from the active task pool for the general processing cluster 800 and one of the other tasks from the pending task pool is selected and scheduled for execution on the general processing cluster 800. If an active task has been idle on the general processing cluster 800, such as while waiting for a data dependency to be resolved, then the active task may be evicted from the general processing cluster 800 and returned to the pending task pool while another task in the pending task pool is selected and scheduled for execution on the general processing cluster 800.

The work distribution unit 710 communicates with the one or more general processing cluster 800 modules via crossbar 714. The crossbar 714 is an interconnect network that couples many of the units of the parallel processing unit 702 to other units of the parallel processing unit 702. For example, the crossbar 714 may be configured to couple the work distribution unit 710 to a particular general processing cluster 800. Although not shown explicitly, one or more other units of the parallel processing unit 702 may also be connected to the crossbar 714 via the hub 712.

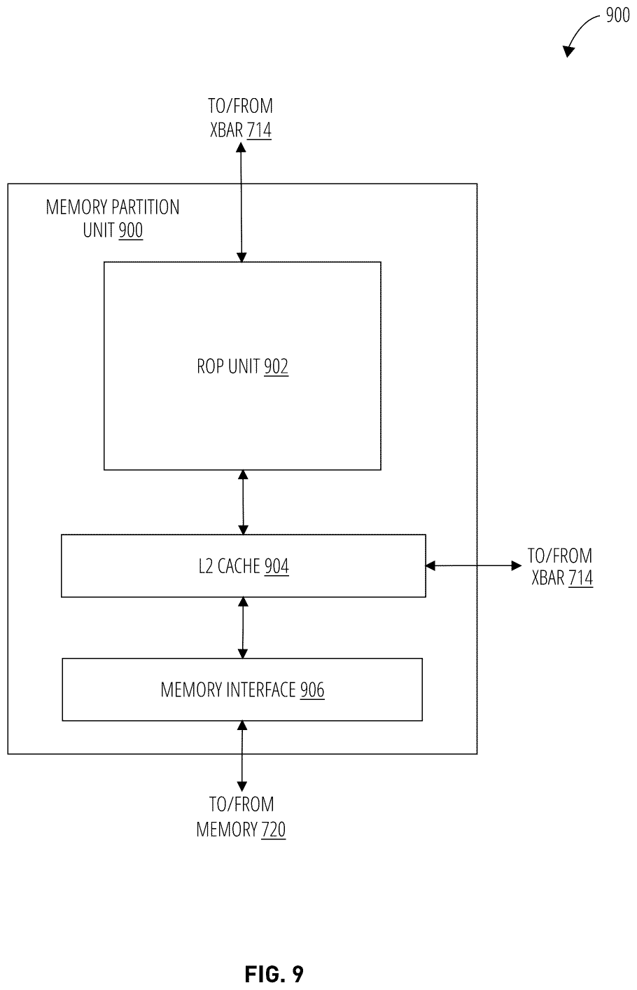

The tasks are managed by the scheduler unit 708 and dispatched to a general processing cluster 800 by the work distribution unit 710. The general processing cluster 800 is configured to process the task and generate results. The results may be consumed by other tasks within the general processing cluster 800, routed to a different general processing cluster 800 via the crossbar 714, or stored in the memory 720. The results can be written to the memory 720 via the memory partition unit 900 modules, which implement a memory interface for reading and writing data to/from the memory 720. The results can be transmitted to another parallel processing unit 702 or CPU via the NVLink 716. In an embodiment, the parallel processing unit 702 includes a number U of memory partition unit 900 modules that is equal to the number of separate and distinct memory 720 devices coupled to the parallel processing unit 702. A memory partition unit 900 will be described in more detail below in conjunction with FIG. 9.

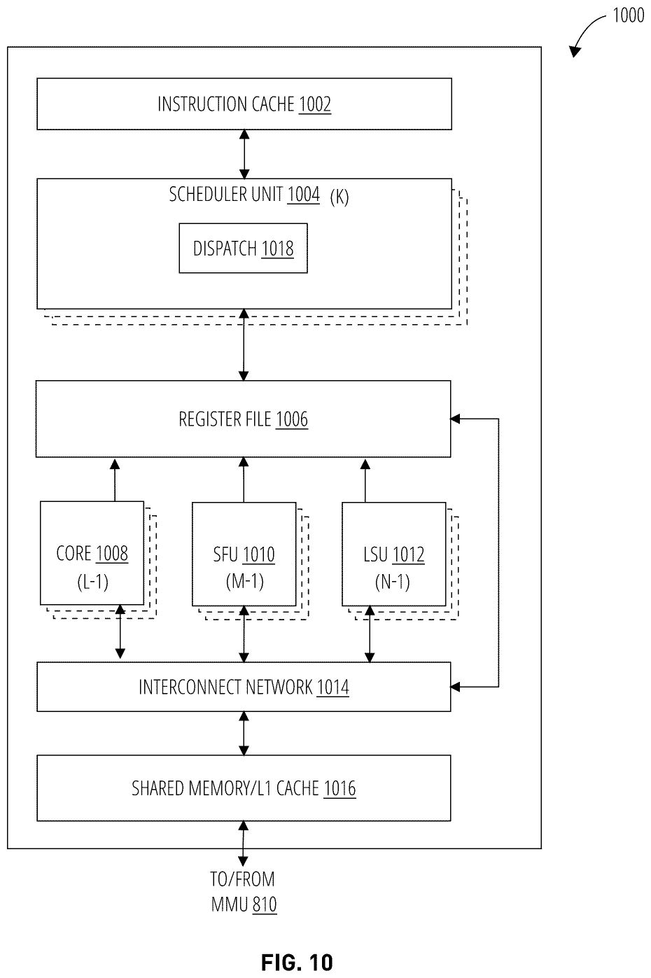

In an embodiment, a host processor executes a driver kernel that implements an application programming interface (API) that enables one or more applications executing on the host processor to schedule operations for execution on the parallel processing unit 702. In an embodiment, multiple compute applications are simultaneously executed by the parallel processing unit 702 and the parallel processing unit 702 provides isolation, quality of service (QoS), and independent address spaces for the multiple compute applications. An application may generate instructions (e.g., API calls) that cause the driver kernel to generate one or more tasks for execution by the parallel processing unit 702. The driver kernel outputs tasks to one or more streams being processed by the parallel processing unit 702. Each task may comprise one or more groups of related threads, referred to herein as a warp. In an embodiment, a warp comprises 32 related threads that may be executed in parallel. Cooperating threads may refer to a plurality of threads including instructions to perform the task and that may exchange data through shared memory. Threads and cooperating threads are described in more detail in conjunction with FIG. 10.

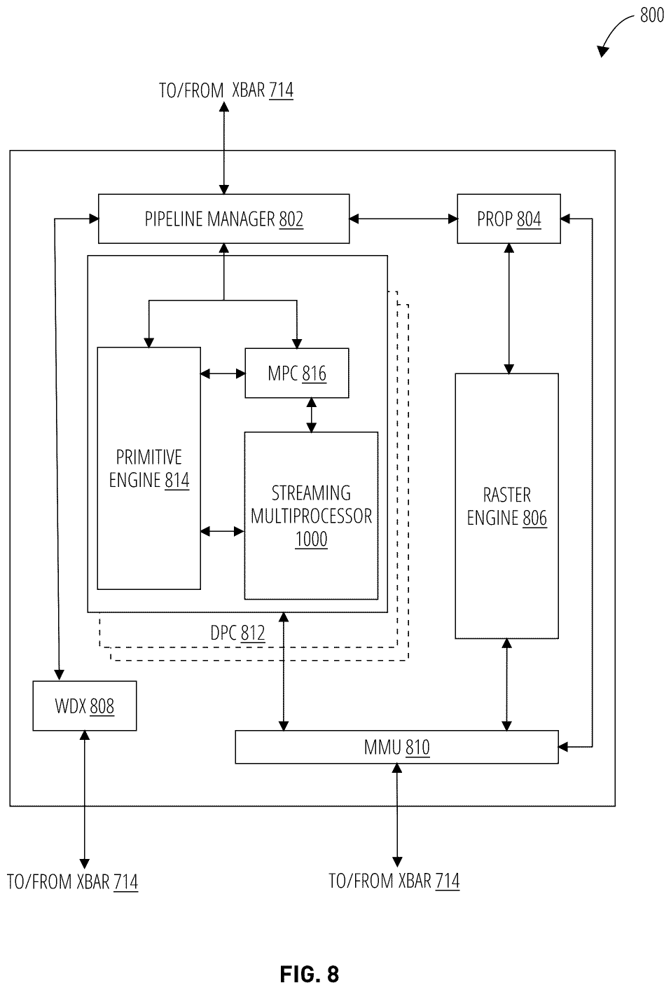

FIG. 8 depicts a general processing cluster 800 of the parallel processing unit 702 of FIG. 7, in accordance with an embodiment. As shown in FIG. 8, each general processing cluster 800 includes a number of hardware units for processing tasks. In an embodiment, each general processing cluster 800 includes a pipeline manager 802, a pre-raster operations unit 804, a raster engine 806, a work distribution crossbar 808, a memory management unit 810, and one or more data processing cluster 812. It will be appreciated that the general processing cluster 800 of FIG. 8 may include other hardware units in lieu of or in addition to the units shown in FIG. 8.

In an embodiment, the operation of the general processing cluster 800 is controlled by the pipeline manager 802. The pipeline manager 802 manages the configuration of the one or more data processing cluster 812 modules for processing tasks allocated to the general processing cluster 800. In an embodiment, the pipeline manager 802 may configure at least one of the one or more data processing cluster 812 modules to implement at least a portion of a graphics rendering pipeline. For example, a data processing cluster 812 may be configured to execute a vertex shader program on the programmable streaming multiprocessor 1000. The pipeline manager 802 may also be configured to route packets received from the work distribution unit 710 to the appropriate logical units within the general processing cluster 800. For example, some packets may be routed to fixed function hardware units in the pre-raster operations unit 804 and/or raster engine 806 while other packets may be routed to the data processing cluster 812 modules for processing by the primitive engine 814 or the streaming multiprocessor 1000. In an embodiment, the pipeline manager 802 may configure at least one of the one or more data processing cluster 812 modules to implement a neural network model and/or a computing pipeline.

The pre-raster operations unit 804 is configured to route data generated by the raster engine 806 and the data processing cluster 812 modules to a Raster Operations (ROP) unit, described in more detail in conjunction with FIG. 9. The pre-raster operations unit 804 may also be configured to perform optimizations for color blending, organize pixel data, perform address translations, and the like.

The raster engine 806 includes a number of fixed function hardware units configured to perform various raster operations. In an embodiment, the raster engine 806 includes a setup engine, a coarse raster engine, a culling engine, a clipping engine, a fine raster engine, and a tile coalescing engine. The setup engine receives transformed vertices and generates plane equations associated with the geometric primitive defined by the vertices. The plane equations are transmitted to the coarse raster engine to generate coverage information (e.g., an x, y coverage mask for a tile) for the primitive. The output of the coarse raster engine is transmitted to the culling engine where fragments associated with the primitive that fail a z-test are culled, and transmitted to a clipping engine where fragments lying outside a viewing frustum are clipped. Those fragments that survive clipping and culling may be passed to the fine raster engine to generate attributes for the pixel fragments based on the plane equations generated by the setup engine. The output of the raster engine 806 comprises fragments to be processed, for example, by a fragment shader implemented within a data processing cluster 812.

Each data processing cluster 812 included in the general processing cluster 800 includes an M-pipe controller 816, a primitive engine 814, and one or more streaming multiprocessor 1000 modules. The M-pipe controller 816 controls the operation of the data processing cluster 812, routing packets received from the pipeline manager 802 to the appropriate units in the data processing cluster 812. For example, packets associated with a vertex may be routed to the primitive engine 814, which is configured to fetch vertex attributes associated with the vertex from the memory 720. In contrast, packets associated with a shader program may be transmitted to the streaming multiprocessor 1000.

The streaming multiprocessor 1000 comprises a programmable streaming processor that is configured to process tasks represented by a number of threads. Each streaming multiprocessor 1000 is multi-threaded and configured to execute a plurality of threads (e.g., 32 threads) from a particular group of threads concurrently. In an embodiment, the streaming multiprocessor 1000 implements a Single-Instruction, Multiple-Data (SIMD) architecture where each thread in a group of threads (e.g., a warp) is configured to process a different set of data based on the same set of instructions. All threads in the group of threads execute the same instructions. In another embodiment, the streaming multiprocessor 1000 implements a Single-Instruction, Multiple Thread (SIMT) architecture where each thread in a group of threads is configured to process a different set of data based on the same set of instructions, but where individual threads in the group of threads are allowed to diverge during execution. In an embodiment, a program counter, call stack, and execution state is maintained for each warp, enabling concurrency between warps and serial execution within warps when threads within the warp diverge. In another embodiment, a program counter, call stack, and execution state is maintained for each individual thread, enabling equal concurrency between all threads, within and between warps. When execution state is maintained for each individual thread, threads executing the same instructions may be converged and executed in parallel for maximum efficiency. The streaming multiprocessor 1000 will be described in more detail below in conjunction with FIG. 10.

The memory management unit 810 provides an interface between the general processing cluster 800 and the memory partition unit 900. The memory management unit 810 may provide translation of virtual addresses into physical addresses, memory protection, and arbitration of memory requests. In an embodiment, the memory management unit 810 provides one or more translation lookaside buffers (TLBs) for performing translation of virtual addresses into physical addresses in the memory 720.

FIG. 9 depicts a memory partition unit 900 of the parallel processing unit 702 of FIG. 7, in accordance with an embodiment. As shown in FIG. 9, the memory partition unit 900 includes a raster operations unit 902, a level two cache 904, and a memory interface 906. The memory interface 906 is coupled to the memory 720. Memory interface 906 may implement 32, 64, 128, 1024-bit data buses, or the like, for high-speed data transfer. In an embodiment, the parallel processing unit 702 incorporates U memory interface 906 modules, one memory interface 906 per pair of memory partition unit 900 modules, where each pair of memory partition unit 900 modules is connected to a corresponding memory 720 device. For example, parallel processing unit 702 may be connected to up to Y memory 720 devices, such as high bandwidth memory stacks or graphics double-data-rate, version 5, synchronous dynamic random access memory, or other types of persistent storage.

Embodiments of the mechanisms disclosed herein may be utilized for example in the memory interface 906.

In an embodiment, the memory interface 906 implements an HBM2 memory interface and Y equals half U. In an embodiment, the HBM2 memory stacks are located on the same physical package as the parallel processing unit 702, providing substantial power and area savings compared with conventional GDDR5 SDRAM systems. In an embodiment, each HBM2 stack includes four memory dies and Y equals 4, with HBM2 stack including two 128-bit channels per die for a total of 8 channels and a data bus width of 1024 bits.

In an embodiment, the memory 720 supports Single-Error Correcting Double-Error Detecting (SECDED) Error Correction Code (ECC) to protect data. ECC provides higher reliability for compute applications that are sensitive to data corruption. Reliability is especially important in large-scale cluster computing environments where parallel processing unit 702 modules process very large datasets and/or run applications for extended periods.

In an embodiment, the parallel processing unit 702 implements a multi-level memory hierarchy. In an embodiment, the memory partition unit 900 supports a unified memory to provide a single unified virtual address space for CPU and parallel processing unit 702 memory, enabling data sharing between virtual memory systems. In an embodiment the frequency of accesses by a parallel processing unit 702 to memory located on other processors is traced to ensure that memory pages are moved to the physical memory of the parallel processing unit 702 that is accessing the pages more frequently. In an embodiment, the NVLink 716 supports address translation services allowing the parallel processing unit 702 to directly access a CPU's page tables and providing full access to CPU memory by the parallel processing unit 702.

In an embodiment, copy engines transfer data between multiple parallel processing unit 702 modules or between parallel processing unit 702 modules and CPUs. The copy engines can generate page faults for addresses that are not mapped into the page tables. The memory partition unit 900 can then service the page faults, mapping the addresses into the page table, after which the copy engine can perform the transfer. In a conventional system, memory is pinned (e.g., non-pageable) for multiple copy engine operations between multiple processors, substantially reducing the available memory. With hardware page faulting, addresses can be passed to the copy engines without worrying if the memory pages are resident, and the copy process is transparent.

Data from the memory 720 or other system memory may be fetched by the memory partition unit 900 and stored in the level two cache 904, which is located on-chip and is shared between the various general processing cluster 800 modules. As shown, each memory partition unit 900 includes a portion of the level two cache 904 associated with a corresponding memory 720 device. Lower level caches may then be implemented in various units within the general processing cluster 800 modules. For example, each of the streaming multiprocessor 1000 modules may implement an L1 cache. The L1 cache is private memory that is dedicated to a particular streaming multiprocessor 1000. Data from the level two cache 904 may be fetched and stored in each of the L1 caches for processing in the functional units of the streaming multiprocessor 1000 modules. The level two cache 904 is coupled to the memory interface 906 and the crossbar 714.

The raster operations unit 902 performs graphics raster operations related to pixel color, such as color compression, pixel blending, and the like. The raster operations unit 902 also implements depth testing in conjunction with the raster engine 806, receiving a depth for a sample location associated with a pixel fragment from the culling engine of the raster engine 806. The depth is tested against a corresponding depth in a depth buffer for a sample location associated with the fragment. If the fragment passes the depth test for the sample location, then the raster operations unit 902 updates the depth buffer and transmits a result of the depth test to the raster engine 806. It will be appreciated that the number of partition memory partition unit 900 modules may be different than the number of general processing cluster 800 modules and, therefore, each raster operations unit 902 may be coupled to each of the general processing cluster 800 modules. The raster operations unit 902 tracks packets received from the different general processing cluster 800 modules and determines which general processing cluster 800 that a result generated by the raster operations unit 902 is routed to through the crossbar 714. Although the raster operations unit 902 is included within the memory partition unit 900 in FIG. 9, in other embodiment, the raster operations unit 902 may be outside of the memory partition unit 900. For example, the raster operations unit 902 may reside in the general processing cluster 800 or another unit.

FIG. 10 illustrates the streaming multiprocessor 1000 of FIG. 8, in accordance with an embodiment. As shown in FIG. 10, the streaming multiprocessor 1000 includes an instruction cache 1002, one or more scheduler unit 1004 modules (e.g., such as scheduler unit 708), a register file 1006, one or more processing core 1008 modules, one or more special function unit 1010 modules, one or more load/store unit 1012 modules, an interconnect network 1014, and a shared memory/L1 cache 1016.

Embodiments of the mechanisms disclosed herein may be utilized for example in the interconnect network 1014.

As described above, the work distribution unit 710 dispatches tasks for execution on the general processing cluster 800 modules of the parallel processing unit 702. The tasks are allocated to a particular data processing cluster 812 within a general processing cluster 800 and, if the task is associated with a shader program, the task may be allocated to a streaming multiprocessor 1000. The scheduler unit 708 receives the tasks from the work distribution unit 710 and manages instruction scheduling for one or more thread blocks assigned to the streaming multiprocessor 1000. The scheduler unit 1004 schedules thread blocks for execution as warps of parallel threads, where each thread block is allocated at least one warp. In an embodiment, each warp executes 32 threads. The scheduler unit 1004 may manage a plurality of different thread blocks, allocating the warps to the different thread blocks and then dispatching instructions from the plurality of different cooperative groups to the various functional units (e.g., core 1008 modules, special function unit 1010 modules, and load/store unit 1012 modules) during each clock cycle.

Cooperative Groups is a programming model for organizing groups of communicating threads that allows developers to express the granularity at which threads are communicating, enabling the expression of richer, more efficient parallel decompositions. Cooperative launch APIs support synchronization amongst thread blocks for the execution of parallel algorithms. Conventional programming models provide a single, simple construct for synchronizing cooperating threads: a barrier across all threads of a thread block (e.g., the syncthreads ( ) function). However, programmers would often like to define groups of threads at smaller than thread block granularities and synchronize within the defined groups to enable greater performance, design flexibility, and software reuse in the form of collective group-wide function interfaces.

Cooperative Groups enables programmers to define groups of threads explicitly at sub-block (e.g., as small as a single thread) and multi-block granularities, and to perform collective operations such as synchronization on the threads in a cooperative group. The programming model supports clean composition across software boundaries, so that libraries and utility functions can synchronize safely within their local context without having to make assumptions about convergence. Cooperative Groups primitives enable new patterns of cooperative parallelism, including producer-consumer parallelism, opportunistic parallelism, and global synchronization across an entire grid of thread blocks.

A dispatch 1018 unit is configured within the scheduler unit 1004 to transmit instructions to one or more of the functional units. In one embodiment, the scheduler unit 1004 includes two dispatch 1018 units that enable two different instructions from the same warp to be dispatched during each clock cycle. In alternative embodiments, each scheduler unit 1004 may include a single dispatch 1018 unit or additional dispatch 1018 units.

Each streaming multiprocessor 1000 includes a register file 1006 that provides a set of registers for the functional units of the streaming multiprocessor 1000. In an embodiment, the register file 1006 is divided between each of the functional units such that each functional unit is allocated a dedicated portion of the register file 1006. In another embodiment, the register file 1006 is divided between the different warps being executed by the streaming multiprocessor 1000. The register file 1006 provides temporary storage for operands connected to the data paths of the functional units.

Each streaming multiprocessor 1000 comprises L processing core 1008 modules. In an embodiment, the streaming multiprocessor 1000 includes a large number (e.g., 128, etc.) of distinct processing core 1008 modules. Each core 1008 may include a fully-pipelined, single-precision, double-precision, and/or mixed precision processing unit that includes a floating point arithmetic logic unit and an integer arithmetic logic unit. In an embodiment, the floating point arithmetic logic units implement the IEEE 754-2008 standard for floating point arithmetic. In an embodiment, the core 1008 modules include 64 single-precision (32-bit) floating point cores, 64 integer cores, 32 double-precision (64-bit) floating point cores, and 8 tensor cores.

Tensor cores configured to perform matrix operations, and, in an embodiment, one or more tensor cores are included in the core 1008 modules. In particular, the tensor cores are configured to perform deep learning matrix arithmetic, such as convolution operations for neural network training and inferencing. In an embodiment, each tensor core operates on a 4×4 matrix and performs a matrix multiply and accumulate operation D=A B+C, where A, B, C, and D are 4×4 matrices.

In an embodiment, the matrix multiply inputs A and B are 16-bit floating point matrices, while the accumulation matrices C and D may be 16-bit floating point or 32-bit floating point matrices. Tensor Cores operate on 16-bit floating point input data with 32-bit floating point accumulation. The 16-bit floating point multiply requires 64 operations and results in a full precision product that is then accumulated using 32-bit floating point addition with the other intermediate products for a 4×4×4 matrix multiply. In practice, Tensor Cores are used to perform much larger two-dimensional or higher dimensional matrix operations, built up from these smaller elements. An API, such as CUDA 9 C++ API, exposes specialized matrix load, matrix multiply and accumulate, and matrix store operations to efficiently use Tensor Cores from a CUDA-C++ program. At the CUDA level, the warp-level interface assumes 16×16 size matrices spanning all 32 threads of the warp.

Each streaming multiprocessor 1000 also comprises M special function unit 1010 modules that perform special functions (e.g., attribute evaluation, reciprocal square root, and the like). In an embodiment, the special function unit 1010 modules may include a tree traversal unit configured to traverse a hierarchical tree data structure. In an embodiment, the special function unit 1010 modules may include texture unit configured to perform texture map filtering operations. In an embodiment, the texture units are configured to load texture maps (e.g., a 2D array of texels) from the memory 720 and sample the texture maps to produce sampled texture values for use in shader programs executed by the streaming multiprocessor 1000. In an embodiment, the texture maps are stored in the shared memory/L1 cache 1016. The texture units implement texture operations such as filtering operations using mip-maps (e.g., texture maps of varying levels of detail). In an embodiment, each streaming multiprocessor 1000 includes two texture units.

Each streaming multiprocessor 1000 also comprises N load/store unit 1012 modules that implement load and store operations between the shared memory/L1 cache 1016 and the register file 1006. Each streaming multiprocessor 1000 includes an interconnect network 1014 that connects each of the functional units to the register file 1006 and the load/store unit 1012 to the register file 1006 and shared memory/L1 cache 1016. In an embodiment, the interconnect network 1014 is a crossbar that can be configured to connect any of the functional units to any of the registers in the register file 1006 and connect the load/store unit 1012 modules to the register file 1006 and memory locations in shared memory/L1 cache 1016.

The shared memory/L1 cache 1016 is an array of on-chip memory that allows for data storage and communication between the streaming multiprocessor 1000 and the primitive engine 814 and between threads in the streaming multiprocessor 1000. In an embodiment, the shared memory/L1 cache 1016 comprises 128 KB of storage capacity and is in the path from the streaming multiprocessor 1000 to the memory partition unit 900. The shared memory/L1 cache 1016 can be used to cache reads and writes. One or more of the shared memory/L1 cache 1016, level two cache 904, and memory 720 are backing stores.

Combining data cache and shared memory functionality into a single memory block provides the best overall performance for both types of memory accesses. The capacity is usable as a cache by programs that do not use shared memory. For example, if shared memory is configured to use half of the capacity, texture and load/store operations can use the remaining capacity. Integration within the shared memory/L1 cache 1016 enables the shared memory/L1 cache 1016 to function as a high-throughput conduit for streaming data while simultaneously providing high-bandwidth and low-latency access to frequently reused data.

When configured for general purpose parallel computation, a simpler configuration can be used compared with graphics processing. Specifically, the fixed function graphics processing units shown in FIG. 7, are bypassed, creating a much simpler programming model. In the general purpose parallel computation configuration, the work distribution unit 710 assigns and distributes blocks of threads directly to the data processing cluster 812 modules. The threads in a block execute the same program, using a unique thread ID in the calculation to ensure each thread generates unique results, using the streaming multiprocessor 1000 to execute the program and perform calculations, shared memory/L1 cache 1016 to communicate between threads, and the load/store unit 1012 to read and write global memory through the shared memory/L1 cache 1016 and the memory partition unit 900. When configured for general purpose parallel computation, the streaming multiprocessor 1000 can also write commands that the scheduler unit 708 can use to launch new work on the data processing cluster 812 modules.

The parallel processing unit 702 may be included in a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, and the like. In an embodiment, the parallel processing unit 702 is embodied on a single semiconductor substrate. In another embodiment, the parallel processing unit 702 is included in a system-on-a-chip (SoC) along with one or more other devices such as additional parallel processing unit 702 modules, the memory 720, a reduced instruction set computer (RISC) CPU, a memory management unit (MMU), a digital-to-analog converter (DAC), and the like.

In an embodiment, the parallel processing unit 702 may be included on a graphics card that includes one or more memory devices. The graphics card may be configured to interface with a PCIe slot on a motherboard of a desktop computer. In yet another embodiment, the parallel processing unit 702 may be an integrated graphics processing unit (iGPU) or parallel processor included in the chipset of the motherboard.

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

FIG. 11 is a conceptual diagram of a processing system 1100 implemented using the parallel processing unit 702 of FIG. 7, in accordance with an embodiment. The processing system 1100 includes a central processing unit 1102, switch 1104, and multiple parallel processing unit 702 modules each and respective memory 720 modules. The NVLink 716 provides high-speed communication links between each of the parallel processing unit 702 modules.

Embodiments of the mechanisms disclosed herein may be utilized for example in a command and data bus between one or more of the parallel processing units 702 and the memories 720, and/or to implement or enhance the switch 1104.

Although a particular number of NVLink 716 and interconnect 718 connections are illustrated in FIG. 11, the number of connections to each parallel processing unit 702 and the central processing unit 1102 may vary. The switch 1104 interfaces between the interconnect 718 and the central processing unit 1102. The parallel processing unit 702 modules, memory 720 modules, and NVLink 716 connections may be situated on a single semiconductor platform to form a parallel processing module 1106. In an embodiment, the switch 1104 supports two or more protocols to interface between various different connections and/or links.

In another embodiment (not shown), the NVLink 716 provides one or more high-speed communication links between each of the parallel processing unit modules (parallel processing unit 702, parallel processing unit 702, parallel processing unit 702, and parallel processing unit 702) and the central processing unit 1102 and the switch 1104 interfaces between the interconnect 718 and each of the parallel processing unit modules. The parallel processing unit modules, memory 720 modules, and interconnect 718 may be situated on a single semiconductor platform to form a parallel processing module 1106. In yet another embodiment (not shown), the interconnect 718 provides one or more communication links between each of the parallel processing unit modules and the central processing unit 1102 and the switch 1104 interfaces between each of the parallel processing unit modules using the NVLink 716 to provide one or more high-speed communication links between the parallel processing unit modules. In another embodiment (not shown), the NVLink 716 provides one or more high-speed communication links between the parallel processing unit modules and the central processing unit 1102 through the switch 1104. In yet another embodiment (not shown), the interconnect 718 provides one or more communication links between each of the parallel processing unit modules directly. One or more of the NVLink 716 high-speed communication links may be implemented as a physical NVLink interconnect or either an on-chip or on-die interconnect using the same protocol as the NVLink 716.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 1106 may be implemented as a circuit board substrate and each of the parallel processing unit modules and/or memory 720 modules may be packaged devices. In an embodiment, the central processing unit 1102, switch 1104, and the parallel processing module 1106 are situated on a single semiconductor platform.

In an embodiment, the signaling rate of each NVLink 716 is 20 to 25 Gigabits/second and each parallel processing unit module includes six NVLink 716 interfaces (as shown in FIG. 11, five NVLink 716 interfaces are included for each parallel processing unit module). Each NVLink 716 provides a data transfer rate of 25 Gigabytes/second in each direction, with six links providing 300 Gigabytes/second. The NVLink 716 can be used exclusively for PPU-to-PPU communication as shown in FIG. 11, or some combination of PPU-to-PPU and PPU-to-CPU, when the central processing unit 1102 also includes one or more NVLink 716 interfaces.

In an embodiment, the NVLink 716 allows direct load/store/atomic access from the central processing unit 1102 to each parallel processing unit module's memory 720. In an embodiment, the NVLink 716 supports coherency operations, allowing data read from the memory 720 modules to be stored in the cache hierarchy of the central processing unit 1102, reducing cache access latency for the central processing unit 1102. In an embodiment, the NVLink 716 includes support for Address Translation Services (ATS), enabling the parallel processing unit module to directly access page tables within the central processing unit 1102. One or more of the NVLink 716 may also be configured to operate in a low-power mode.

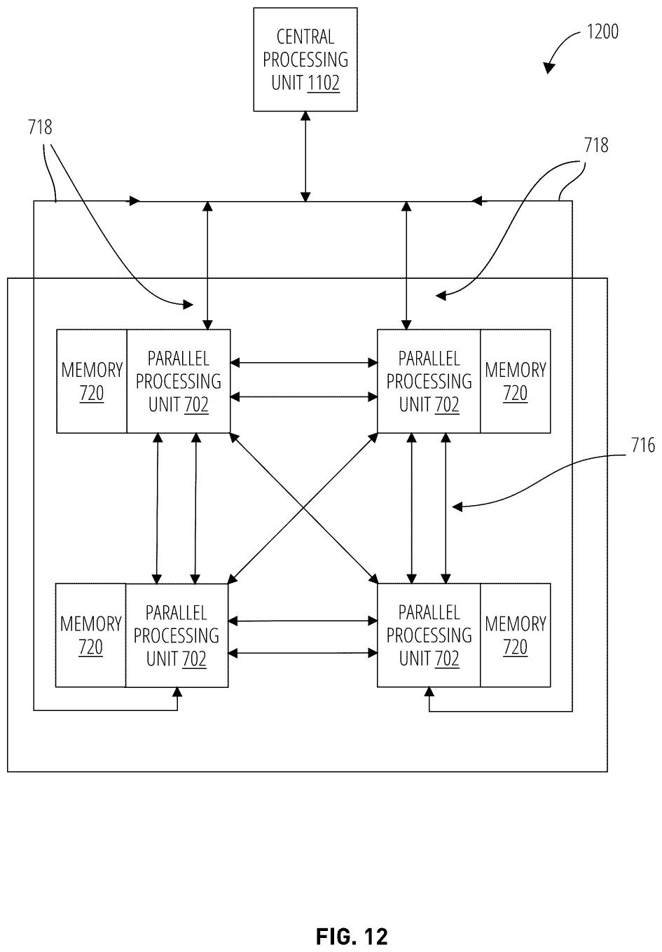

FIG. 12 is a conceptual diagram of a processing system 1200 in accordance with another embodiment. The processing system 1200 comprises similar features to the processing system 1100 depicted in FIG. 11, except that the intervening switch 1104 between the parallel processing units 702 and the one or more central processing units 1102 is obviated in favor of a more direct link. Obviating the switch 1104 may enable higher bandwidth between the parallel processing units 702 and the central processing unit(s) 1102 and may also reduce circuit area and/or power consumption.

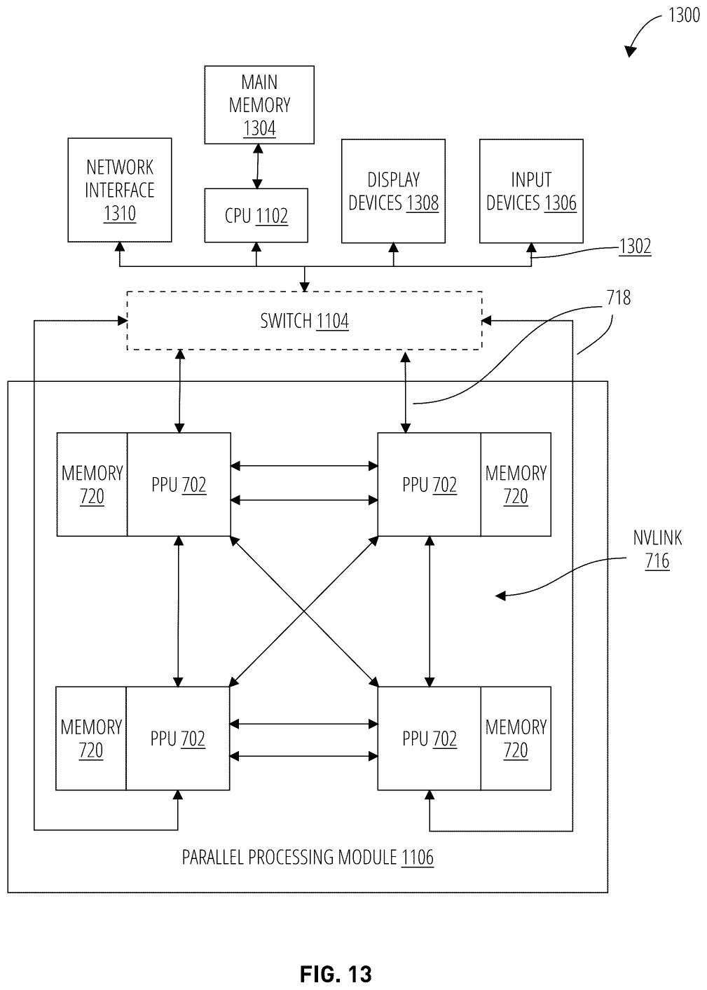

FIG. 13 depicts an exemplary processing system 1300 in which the various architecture and/or functionality of the various previous embodiments may be implemented. As shown, an exemplary processing system 1300 is provided including at least one central processing unit 1102 that is connected to a communications bus 1302. The communication communications bus 1302 may be implemented using any suitable protocol, such as PCI (Peripheral Component Interconnect), PCI-Express, AGP (Accelerated Graphics Port), HyperTransport, or any other bus or point-to-point communication protocol(s). The exemplary processing system 1300 also includes a main memory 1304. Control logic (software) and data are stored in the main memory 1304 which may take the form of random access memory (RAM).

The exemplary processing system 1300 also includes input devices 1306, the parallel processing module 1106, and display devices 1308, e.g. a conventional CRT (cathode ray tube), LCD (liquid crystal display), LED (light emitting diode), plasma display or the like. User input may be received from the input devices 1306, e.g., keyboard, mouse, touchpad, microphone, and the like. Each of the foregoing modules and/or devices may even be situated on a single semiconductor platform to form the exemplary processing system 1300. Alternately, the various modules may also be situated separately or in various combinations of semiconductor platforms per the desires of the user.

Further, the exemplary processing system 1300 may be coupled to a network (e.g., a telecommunications network, local area network (LAN), wireless network, wide area network (WAN) such as the Internet, peer-to-peer network, cable network, or the like) through a network interface 1310 for communication purposes.

The exemplary processing system 1300 may also include a secondary storage (not shown). The secondary storage includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner.

Computer programs, or computer control logic algorithms, may be stored in the main memory 1304 and/or the secondary storage. Such computer programs, when executed, enable the exemplary processing system 1300 to perform various functions. The main memory 1304, the storage, and/or any other storage are possible examples of computer-readable media.

The architecture and/or functionality of the various previous figures may be implemented in the context of a general computer system, a circuit board system, a game console system dedicated for entertainment purposes, an application-specific system, and/or any other desired system. For example, the exemplary processing system 1300 may take the form of a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, a mobile phone device, a television, workstation, game consoles, embedded system, and/or any other type of logic.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

### LISTING OF DRAWING ELEMENTS

102 central network
104 leaf network
202 initiator component
204 switching network
206 target component
208 re-timing circuits
302 converter
304 converter
306 central network
308 re-timing circuits
310 switching network
402 graphics processing unit
404 graphics processing unit
502 AXI bus
504 reduced bus
506 FIFO
508 credit checker
510 FIFO
512 arbiter
514 packetizer
516 de-packetizer
518 AXI bus
520 arbiter
522 packetizer
524 de-packetizer
526 credit checker
528 AXI physical channels
530 reduced bus response channel
532 reduced bus request channel
702 parallel processing unit
704 I/O unit
706 front-end unit
708 scheduler unit
710 work distribution unit
712 hub
714 crossbar
716 NVLink
718 interconnect
720 memory
800 general processing cluster
802 pipeline manager
804 pre-raster operations unit
806 raster engine
808 work distribution crossbar
810 memory management unit
812 data processing cluster
814 primitive engine
816 M-pipe controller
900 memory partition unit
902 raster operations unit
904 level two cache
906 memory interface
1000 streaming multiprocessor
1002 instruction cache
1004 scheduler unit
1006 register file
1008 core
1010 special function unit
1012 load/store unit
1014 interconnect network
1016 shared memory/L1 cache
1018 dispatch
1100 processing system
1102 central processing unit
1104 switch
1106 parallel processing module
1200 processing system
1202 general-purpose processor
1204 switch
1206 parallel processing module
1208 memory
1210 NVLink
1212 interconnect
1214 parallel processing unit
1216 non-volatile memory
1220
1222 CPU(s)
1224 PPU
1226 PPU
1228 PPU
1230 PPU
1232
1234
1236
1238
1300 exemplary processing system
1302 communications bus
1304 main memory
1306 input devices
1308 display devices
1310 network interface

Various functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on. “Logic” refers to machine memory circuits and non-transitory machine readable media comprising machine-executable instructions (software and firmware), and/or circuitry (hardware) which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter). Logic symbols in the drawings should be understood to have their ordinary interpretation in the art in terms of functionality and various structures that may be utilized for their implementation, unless otherwise indicated.

Within this disclosure, different entities (which may variously be referred to as “units,” “circuits,” other components, etc.) may be described or claimed as “configured” to perform one or more tasks or operations. This formulation-[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “credit distribution circuit configured to distribute credits to a plurality of processor cores” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112(f) for that claim element. Accordingly, claims in this application that do not otherwise include the “means for” [performing a function] construct should not be interpreted under 35 U.S.C § 112(f).

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. For example, in a register file having eight registers, the terms “first register” and “second register” can be used to refer to any two of the eight registers, and not, for example, just logical registers 0 and 1.

When used in the claims, the term “or” is used as an inclusive or and not as an exclusive or. For example, the phrase “at least one of x, y, or z” means any one of x, y, and z, as well as any combination thereof.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

Although the terms “step” and/or “block” may be used herein to connote different elements of methods employed, the terms should not be interpreted as implying any particular order among or between various steps herein disclosed unless and except when the order of individual steps is explicitly described.

Having thus described illustrative embodiments in detail, it will be apparent that modifications and variations are possible without departing from the scope of the intended invention as claimed. The scope of inventive subject matter is not limited to the depicted embodiments but is rather set forth in the following Claims.

What is claimed is:

1. A signaling interface comprising:
a plurality of physical channels for requests;
a plurality of physical channels for responses to the requests;
a plurality of first-in-first-out (FIFO) request buffers each configured to receive signals from one of the physical channels for the requests;
a first packetizer configured to transform, into packets on a reduced bus, (a) signals from the physical channels for the requests, and (b) credit signals for responses to the requests; and
wherein a request channel on the reduced bus comprises a width narrower than a combined width of the physical channels for the requests.

2. The signaling interface of claim 1, further configured such that credit signals for the FIFO request buffers are communicated over a response channel on the reduced bus.

3. The signaling interface of claim 1, further comprising:
a plurality of FIFO response buffers each configured to receive signals from one of the physical channels for responses.

4. The signaling interface of claim 3, further comprising:
a second packetizer configured to transform, into packets on a response channel of the reduced bus, (a) signals from the different physical channels for responses, and (b) credit signals for the FIFO request buffers.

5. The signaling interface of claim 4, further configured such that the credit signals for the FIFO response buffers are communicated over the request channel of the reduced bus.

6. The signaling interface of claim 1, further comprising:
a plurality of FIFO response buffers each configured to receive signals from one of the physical channels for responses;
an arbiter for the request channel of the reduced bus; and
the arbiter configured to receive credit signals for the FIFO response buffers.

7. The signaling interface of claim 6, wherein one or both of the credit signals for the FIFO response buffers and the arbiter are configured such that the credit signals for the FIFO response buffers have a highest priority at the arbiter.

8. The signaling interface of claim 1, further comprising:
an arbiter for a response channel of the reduced bus; and
the arbiter configured to receive the credit signals for the FIFO request buffers.

9. The signaling interface of claim 8, wherein one or both of the credit signals for the FIFO request buffers and the arbiter are configured such that the credit signals for the FIFO request buffers have a highest priority at the arbiter.

10. The signaling interface of claim 1, wherein the physical channels for requests comprise a memory READ command channel, a memory WRITE command channel, and a memory WRITE data channel.

11. The signaling interface of claim 10, wherein a width of the request channel of the reduced bus is configured equal to a width of the memory WRITE data channel.

12. The signaling interface of claim 1, wherein the physical channels for responses comprise a READ data channel and a WRITE response channel.

13. The signaling interface of claim 12, wherein a width of a response channel of the reduced bus is configured equal to a width of the READ data channel.

14. A communication network comprising:
a first circuit coupled to a first communication interface comprising a request bus and a response bus;
a second circuit coupled to a second communication interface comprising the request bus and the response bus;
the request bus and the response bus coupled to a reduced bus;
a plurality of FIFO request buffers each configured to receive signals from one of a plurality of physical channels of the request bus;
logic configured to transform signals on the different physical channels of the request bus and credit signals for the FIFO request buffers into packets on the reduced bus; and
wherein the reduced bus comprises a width narrower than a combined width of the request bus and the response bus.

15. The communication network of claim 14, wherein the first circuit is a processor and the second circuit is a memory.

16. The communication network of claim 14, wherein the first communication interface and the second communication interface each comprise an Advanced extensible Interface (AXI).

17. The communication network of claim 14, configured such that the credit signals for the FIFO request buffers are communicated over the response bus.

18. The communication network of claim 14, further comprising:
a plurality of FIFO response buffers each configured to receive signals from one of the physical channels of the response bus.

19. The signaling interface of claim 18, further comprising:
logic to transform signals on the different physical channels of the response bus and credit signals for the FIFO response buffers into packets on the reduced bus.

20. A communication fabric comprising:
a central network;
a plurality of leaf networks;
the central network comprising multiple AXI interfaces between communication initiator circuits and communication target circuits;
the AXI interfaces each comprising a request bus and a response bus;
wherein a plurality of the AXI interfaces are coupled to one another via bus reduction logic comprising:
a reduced bus comprising a request channel and a response channel;
a plurality of FIFO request buffers each configured to receive signals from one of a plurality of physical channels of the request bus via the request channel of the reduced bus;
a plurality of FIFO response buffers each configured to receive signals from one of a plurality of physical channels of the response bus via the response channel of the reduced bus; and
a first converter configured to transform signals on different physical channels of the request bus and credit signals for the FIFO response buffers into packets on the request channel, wherein packets for the credit signals are prioritized over packets for the signals on the different physical channels of the request bus, the request channel comprising a width equal to a width of a memory data channel of the AXI interfaces.
